(19) United States
(12) Patent Application Publication
(10) Pub. No.: US 2026/0238095 A1
(43) Pub. Date: Aug. 13, 2026

(54) AXIAL SLIP RING ASSEMBLY FOR AN ELECTRIC MOTOR

(71) Applicant: GM Global Technology Operations LLC, Detroit, MI (US)

(72) Inventors: Edward W. Mellet, Rochester Hills, MI (US); Leonid Basin, Farmington Hills, MI (US); Bradford E. Vorbeck, Clarkston, MI (US); Ajay Mehta, Auburn Hills, MI (US)

(21) Appl. No.: 19/049,357

(22) Filed: Feb. 10, 2025

(51) Int. Cl. H02K 13/00; H01R 39/08; H02K 5/14; H02K 7/116; H02K 11/215

(52) U.S. Cl. CPC H02K 13/003; H01R 39/08; H02K 5/141; H02K 7/116; H02K 11/215

(57) ABSTRACT

An axial slip ring assembly for enabling power transfer in a separately excited motor (SEM) rotor includes a slip ring housing, a first slip ring, a second slip ring, a brush housing, a plurality of brushes, and a plurality of springs. The slip ring housing is mounted to a rotor shaft of the SEM rotor, rotating about an axis of rotation. The first slip ring and the second slip ring are connected to a coil winding of the SEM rotor and are disposed within the slip ring housing. The brush housing includes an axial brush housing face perpendicular to the axis of rotation. The plurality of brushes and the plurality of springs are disposed within the brush housing. The plurality of springs applies an axial force, urging the plurality of brushes to apply a constant axial force against the first slip ring and the second slip ring.

### INTRODUCTION

The present disclosure relates to a slip ring assembly for an electric motor. More specifically, the present disclosure relates to an axial slip ring assembly for axially transferring an electric current to a synchronous electric motor (SEM) rotor.

The SEM generally includes a stator and a rotor. Instead of permanent magnets in the rotor, the SEM includes a coil winding which generates a magnetic field. The magnetic field of the rotor can be adjusted by applying the electric current to the coil winding. A power source, external to the rotor, applies the electric current to a radial slip ring assembly, which transfers the electric current to the coil winding, rotating the rotor.

A radial installation sleeve is used to install the radial slip ring assembly on the rotor. The radial installation sleeve takes up a packaging space while installing the radial slip ring assembly. The packaging space of the radial installation sleeve limits positioning opportunities for the radial slip ring assembly on the rotor.

Thus, to decrease the packaging space and to increase the positioning opportunities for the slip ring assembly on the rotor, there is a need for a new and improved system for the slip ring assembly.

### SUMMARY

According to several aspects, an axial slip ring assembly for enabling a power transfer in a separately excited motor (SEM) rotor including a rotor shaft and a coil winding is provided. The SEM rotor defines an axis of rotation. The axial slip ring assembly includes a slip ring housing. The slip ring housing is mounted to the rotor shaft of the SEM rotor. The slip ring housing rotates about the axis of rotation. The axial slip ring assembly further includes a first slip ring. The first slip ring is disposed within the slip ring housing and rotates with the slip ring housing. The first slip ring is connected to the coil winding of the SEM rotor. The first slip ring is perpendicular to the axis of rotation. The axial slip ring assembly further includes a second slip ring. The second slip ring is disposed within the slip ring housing and rotates with the slip ring housing. The second slip ring is connected to the coil winding of the SEM rotor. The second slip ring is perpendicular to the axis of rotation. The second slip ring is positioned radially outward from the first slip ring. The axial slip ring assembly further includes a brush housing. The brush housing includes an axial brush housing face. The axial brush housing face is perpendicular to the axis of rotation. The axial slip ring assembly further includes a plurality of brushes. The plurality of brushes is disposed within the brush housing. The axial slip ring assembly further includes a plurality of springs. The plurality of springs is disposed within the brush housing. The plurality of springs applies an axial force along the axis of rotation to urge the plurality of brushes to apply a constant axial force against the first slip ring and the second slip ring.

In an additional aspect of the present disclosure, the slip ring housing further includes an axial slip ring housing face disposed parallel to the axial brush housing face.

In another aspect of the present disclosure, the slip ring housing further includes an inner groove. The first slip ring is disposed within the inner groove.

In another aspect of the present disclosure, the slip ring housing further includes an outer groove. The second slip ring is disposed within the outer groove. The outer groove is radially outward from the inner groove.

In another aspect of the present disclosure, the slip ring housing further includes a middle surface. The middle surface is positioned between the inner groove and the outer groove.

In another aspect of the present disclosure, the axial brush housing face defines slots parallel to the axis of rotation. The plurality of brushes is disposed within the slots. The plurality of springs is disposed within the slots.

In another aspect of the present disclosure, the plurality of brushes further includes a first end. The first end is in contact with the plurality of springs. The plurality of brushes further includes a second end. The second end opposes the first end. The second end applies a constant axial force against the first slip ring and the second slip ring along the axis of rotation.

In another aspect of the present disclosure, the axial slip ring assembly further includes a static structure. The static structure is stationary. The brush housing is mounted to the static structure.

In another aspect of the present disclosure, the plurality of brushes, the first slip ring, and the second slip ring are axially aligned.

In another aspect of the present disclosure, the plurality of brushes, the first slip ring, and the second slip ring are axially staggered.

In another aspect of the present disclosure, the plurality of brushes is circumferentially staggered within the brush housing.

In another aspect of the present disclosure, the plurality of brushes is circumferentially aligned within the brush housing.

In another aspect of the present disclosure, the plurality of brushes includes a positive set and a negative set.

In another aspect of the present disclosure, the axial slip ring assembly further includes a power source. The power source applies a current to the plurality of brushes.

In another aspect of the present disclosure, the plurality of brushes transfers the current to the first slip ring through the coil winding to the second slip ring.

In another aspect of the present disclosure, the first slip ring transfers the current to the coil winding. The current in the coil winding creates a magnetic field, rotating the SEM rotor.

According to several aspects, a separately excited motor (SEM) rotor to enable a power transfer defining an axis of rotation is provided. The SEM rotor includes a rotor shaft. The rotor shaft rotates about the axis of rotation. The SEM rotor further includes a laminate. The laminate is connected to the rotor shaft. The laminate rotates with the rotor shaft. The SEM rotor further includes a coil winding. The coil winding is wound within the laminate. The SEM rotor further includes a gear. The gear is mounted to the rotor shaft. The gear rotates with the rotor shaft. The SEM rotor further includes an axial slip ring assembly. The axial slip ring assembly includes a slip ring housing. The slip ring housing is mounted to the rotor shaft. The slip ring housing rotates with the rotor shaft. The axial slip ring assembly further includes a first slip ring. The first slip ring is disposed within the slip ring housing. The first slip ring rotates with the slip ring housing. The first slip ring is connected to the coil winding of the SEM rotor. The first slip ring is perpendicular to the axis of rotation. The axial slip ring assembly further includes a second slip ring. The second slip ring is disposed within the slip ring housing. The second slip ring rotates with the slip ring housing. The second slip ring is connected to the coil winding of the SEM rotor. The second slip ring is perpendicular to the axis of rotation. The second slip ring is positioned radially outward from the first slip ring. The axial slip ring assembly further includes a brush housing. The brush housing includes an axial brush housing face. The axial brush housing face is perpendicular to the axis of rotation. The axial slip ring assembly further includes a static structure. The static structure is stationary. The brush housing is mounted to the static structure. The axial slip ring assembly further includes a plurality of brushes. The plurality of brushes is disposed within the brush housing. The axial slip ring assembly further includes a plurality of springs. The plurality of springs is disposed within the brush housing. The plurality of springs apply an axial force along the axis of rotation to urge the plurality of brushes in contact with the first slip ring and the second slip ring. The axial slip ring assembly further includes a power source. The power source supplies a current to the plurality of brushes. The plurality of brushes transfers the current from the power source to the first slip ring through the coil winding to the second slip ring. The first slip ring transfers the current to the coil winding. The current in the coil winding creates a magnetic field, rotating the SEM rotor about the axis of rotation.

In another aspect of the present disclosure, the SEM rotor further includes a ferrous wheel. The ferrous wheel is attached to the gear. The ferrous wheel rotates with the rotor shaft.

In another aspect of the present disclosure, the SEM rotor further includes a speed sensor. The speed sensor is stationary. The speed sensor is adjacent to the ferrous wheel. The speed sensor calculates the speed of the rotor by detecting the ferrous wheel while the ferrous wheel rotates.

According to several aspects, an axial slip ring assembly for enabling a power transfer in a separately excited motor (SEM) rotor including a rotor shaft and a coil winding is provided. The SEM rotor defines an axis of rotation. The axial slip ring assembly includes a slip ring housing. The slip ring housing is mounted to the rotor shaft of the SEM rotor. The slip ring housing rotates about the axis of rotation. The axial slip ring assembly further includes a first slip ring. The first slip ring is disposed within the slip ring housing. The first slip ring rotates with the slip ring housing. The first slip ring is connected to the coil winding of the SEM rotor. The first slip ring is perpendicular to the axis of rotation. The axial slip ring assembly further includes a second slip ring. The second slip ring is disposed within the slip ring housing. The second slip ring rotates with the slip ring housing. The second slip ring is connected to the coil winding of the SEM rotor. The second slip ring is perpendicular to the axis of rotation. The second slip ring is positioned radially outward from the first slip ring. The axial slip ring assembly further includes a brush housing. The brush housing includes an axial brush housing face. The axial brush housing face is disposed perpendicular to the axis of rotation. The axial slip ring assembly further includes a static structure. The static structure is stationary. The brush housing is mounted to the static structure. The axial slip ring assembly further includes a plurality of brushes. The plurality of brushes is disposed within the brush housing. The axial slip ring assembly further includes a plurality of springs. The plurality of springs is disposed within the brush housing. The plurality of springs applies an axial force along the axis of rotation to urge the plurality of brushes to apply a constant axial force against the first slip ring and the second slip ring. The axial slip ring assembly further includes a power source. The power source applies a current to the plurality of brushes. The plurality of brushes transfers the current to the first slip ring through the coil winding to the second slip ring. The first slip ring transfers the current to the coil winding. The current in the coil winding creates a magnetic field, rotating the SEM rotor about the axis of rotation.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a cross-section view of an axial slip ring assembly installed on a synchronous electric motor (SEM) rotor according to an exemplary embodiment.

FIG. 2 is an end view of the axial slip ring assembly according to an exemplary embodiment.

FIG. 3 is an end view of an alternate axial slip ring assembly according to an exemplary embodiment.

FIG. 4 is a cross-section view of an alternate axial slip ring assembly installed on an SEM rotor according to an exemplary embodiment.

### DETAILED DESCRIPTION

The following description is merely exemplary in nature and is not intended to limit the present disclosure, application, or uses.

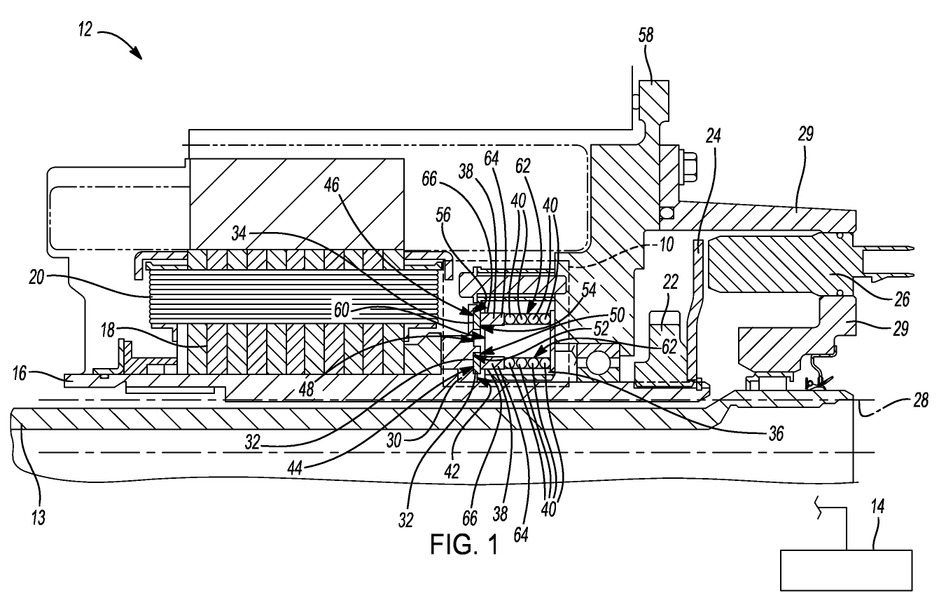

Referring to FIG. 1, a cross-section view of an axial slip ring assembly 10 installed on a synchronous electric motor (SEM) rotor 12 is illustrated. The SEM rotor 12 is part of an SEM 13. A power source 14, external to the SEM 13, applies a current to the axial slip ring assembly 10. The power source 14 may be, but is not limited to, a direct current (DC) power source. The axial slip ring assembly 10 transfers the current from the power source 14 to the SEM rotor. When the current is transferred to the SEM rotor 12, the current is converted into mechanical energy, rotating the SEM rotor 12. The SEM rotor 12 includes a rotor shaft 16, a laminate 18, a coil winding 20, a gear 22, a ferrous wheel 24, and a speed sensor 26.

The rotor shaft 16 defines an axis of rotation 28 about which the rotor shaft 16 rotates. The laminate 18 is connected to the rotor shaft 16 and rotates with the rotor shaft 16. The coil winding 20 is wound about the laminate 18 and rotates with the laminate 18. When the current is transferred to the coil winding 20, the coil winding 20 creates a magnetic field, causing the SEM rotor 12 to rotate about the axis of rotation 28. The current transfer is described in further detail below.

The gear 22 is mounted on the rotor shaft 16 and rotates with the rotor shaft 16. The rotation is a form of mechanical energy and the gear 22 transfers the mechanical energy. For example, the gear 22 may transfer the mechanical energy to a machine (not shown) that the SEM rotor 12 may be disposed within. The ferrous wheel 24 is attached to the gear 22, rotating with the gear 22. The ferrous wheel 24 is composed of a ferrous material such as, but not limited to, iron or steel. The speed sensor 26 is mounted on a stationary portion 29 of the SEM 13 and the speed sensor 26 is positioned adjacent to the ferrous wheel 24. While the ferrous wheel 24 rotates, the speed sensor 26 detects the rotation of the ferrous wheel 24 and calculates the rotational speed of the ferrous wheel 24. The ferrous wheel 24 rotates with the rotor shaft 16 at the same rotational speed as the SEM rotor 12, resulting in the speed sensor 26 calculating the speed of the SEM rotor 12.

For the SEM rotor 12 to rotate, the axial slip ring assembly 10 is axially installed on the SEM rotor 12 to transfer the current from the power source 14 to the coil winding 20. The axial installation of the axial slip ring assembly 10 allows the axial slip ring assembly 10 to be installed without the use of an installation sleeve, decreasing the packaging space during installation. The decreased packaging space increases positioning opportunities of the axial slip ring assembly 10 on the SEM rotor 12. The axial slip ring assembly 10 includes a slip ring housing 30, a first slip ring 32, a second slip ring 34, a brush housing 36, a plurality of brushes 38, and a plurality of springs 40.

The slip ring housing 30 is axially installed on the SEM rotor 12 and mounted to the rotor shaft 16. The slip ring housing 30 rotates about the axis of rotation 28 with the rotor shaft 16. The slip ring housing 30 includes an axial slip ring housing face 42, an inner groove 44, an outer groove 46, and a middle surface 48.

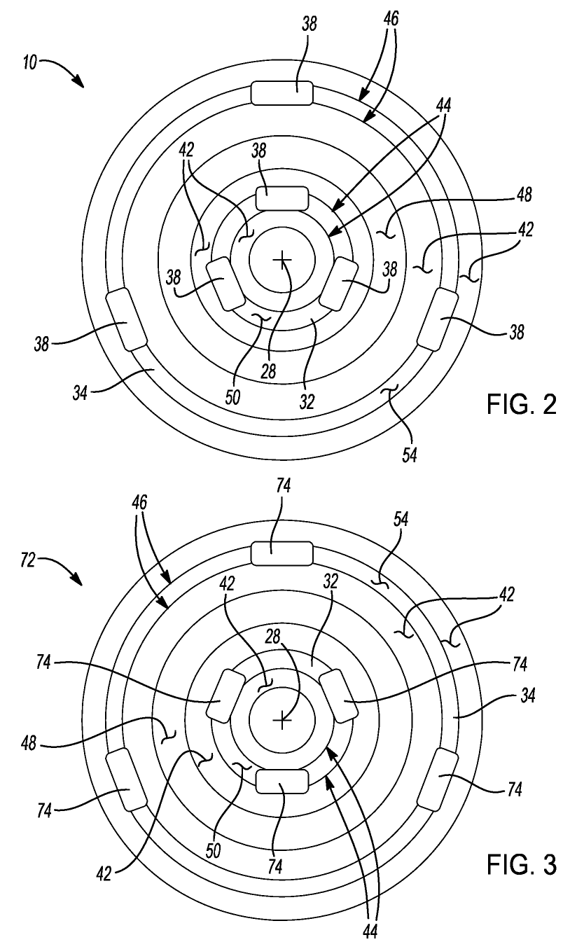

The axial slip ring housing face 42 is perpendicular to the axis of rotation 28. The inner groove 44, the outer groove 46, and the middle surface 48 are disposed on the axial slip ring housing face 42. As better shown in FIGS. 2 and 3, the outer groove 46 is radially outward from the inner groove 44. The middle surface 48 is positioned between the inner groove 44 and the outer groove 46.

Referring back to FIG. 1, the first slip ring 32 is perpendicular to the axis of rotation 28 and is disposed within the inner groove 44 of the slip ring housing 30. The first slip ring 32 includes a first radial slip ring face 50 and a first rear surface 52. The first radial slip ring face 50 is axially aligned with the axial slip ring housing face 42. The first rear surface 52 opposes the first radial slip ring face 50. The first rear surface 52 is in contact with the coil winding 20, allowing the current to transfer in or out of the coil winding 20.

The second slip ring 34 is perpendicular to the axis of rotation 28 and is disposed within the outer groove 46 of the slip ring housing 30. The second slip ring 34 is disposed radially outward from the first slip ring 32. The second slip ring 34 includes a second radial slip ring face 54 and a second rear surface 56. The second radial slip ring face 54 is axially aligned with the axial slip ring housing face 42. The second rear surface 56 opposes the second radial slip ring face 54. The second rear surface 56 is in contact with the coil winding 20, allowing the current to transfer in or out of the coil winding 20.

The brush housing 36 is axially installed on SEM rotor 12 and is positioned adjacent to the slip ring housing 30. The brush housing 36 is mounted to a static structure 58, causing the brush housing 36 to be stationary and not rotate. The brush housing 36 may be, but is not limited to, directly mounted to the static structure 58 with a bolt or a screw. The brush housing 36 includes an axial brush housing face 60. The axial brush housing face 60 is perpendicular to the rotor shaft 16 and parallel to the axial slip ring housing face 42. The axial brush housing face 60 defines a plurality of slots 62. The plurality of slots 62 are perpendicular to the axial brush housing face 60. The plurality of brushes 38 and the plurality of springs 40 are disposed within the plurality of slots 62.

The plurality of brushes 38 is connected to the power source 14. The power source 14 applies a current to the plurality of brushes 38. The plurality of brushes 38 includes a first end 64 and a second end 66. The first end 64 opposes the second end 66. The first end is in contact with the plurality of springs 40. The plurality of springs 40 apply a consistent axial force along the axis of rotation 28 against the first end 64. The consistent axial force against the first end 64 urges the second end 66 of the plurality of brushes 38 to apply a constant axial force against the first radial slip ring face 50 and the second radial slip ring face 54. The constant axial force against the first radial slip ring face 50 and the second radial slip ring face 54 allows the current from the power source 14 to transfer axially from the plurality of brushes 38 to the first slip ring 32 and the second slip ring 34. The plurality of brushes 38 further includes a positive set (not shown) and a negative set (not shown).

The positive set (not shown) transfers the current from the power source 14 to the coil winding 20. For example, the positive set may create the constant axial force against the first radial slip ring face 50. If the positive set creates the constant axal force against the first radial slip ring face 50, the current applied by the power source is transferred to the first slip ring 32. The first slip ring 32 is attached to the coil winding 20, transferring the current to the coil winding 20.

The negative set (not shown) transfers the current from the coil winding 20 back to the power source 14. For example, the negative set may apply the constant axial force against the second radial slip ring face 54. If the negative set applies the constant axial force against the second radial slip ring face 54, the second slip ring 34 transfers the current from the coil winding 20 to the negative set. The negative set of the plurality of brushes 38 transfers the current back to the power source 14.

Referring to FIG. 2, an end view of the axial slip ring assembly 10 is illustrated. The plurality of brushes 38 creates a constant axial force against the first radial slip ring face 50 and against the second radial slip ring face 54. The plurality of brushes 38 is circumferentially aligned within the brush housing 36 (shown in FIG. 1). While the first slip ring 32 and the second slip ring 34 rotate about the axis of rotation 28, the plurality of brushes 38 apply a constant axial force against the first slip ring 32 and the second slip ring 34. The constant axial force causes the plurality of brushes 38 to trace the first radial slip ring face 50 and the second radial slip ring face 54.

Referring to FIG. 3, an alternate embodiment of the axial slip ring assembly 10, indicated by reference number 72, is illustrated. The axial slip ring assembly 72 includes the axis of rotation 28, the first slip ring 32, the second slip ring 34, the first radial slip ring face 50, the second radial slip ring face 54, and the middle surface 48 as shown in FIGS. 1 and 2. The axial slip ring assembly 72 further includes a plurality of brushes 74. The plurality of brushes 74 are circumferentially staggered within the brush housing 36 (shown in FIG. 1). While the first slip ring 32 and the second slip ring 34 rotate about the axis of rotation 28, the plurality of brushes 74 create a constant force with the first slip ring 32 and the second slip ring 34. The constant force, from the plurality of brushes 74 against the first slip ring 32 and the second slip ring 34, causes the plurality of brushes 74 to trace the first radial slip ring face 50 and the second radial slip ring face 54.

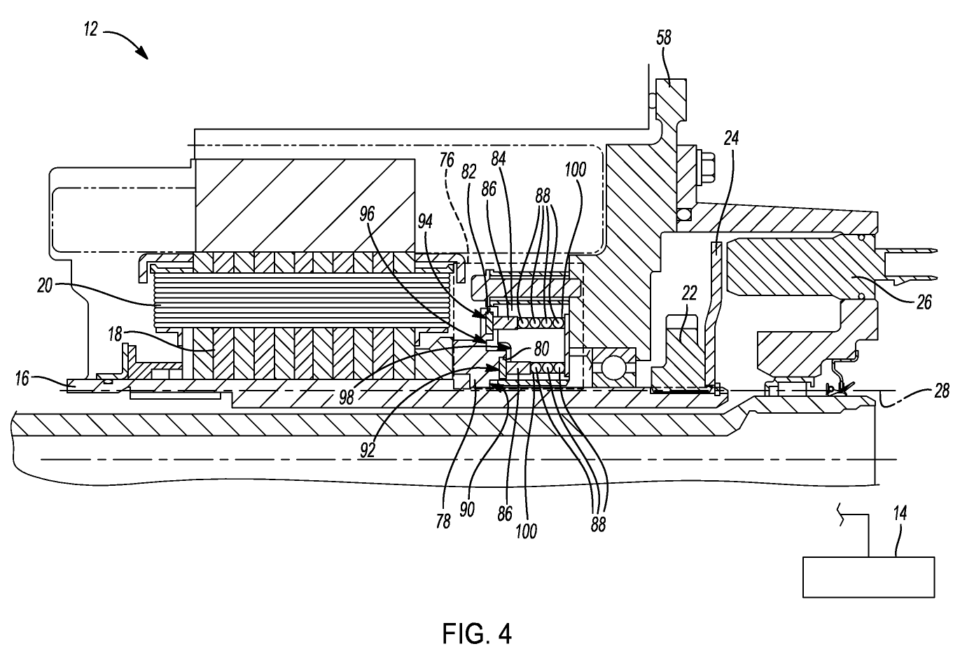

Referring to FIG. 4, a cross-section view of an alternate embodiment of the axial slip ring 10, indicated by reference number 76, installed on the SEM rotor 12 is illustrated. The SEM rotor 12 includes the power source 14, the rotor shaft 16, the laminate 18, the coil winding 20, the gear 22, the ferrous wheel 24, the speed sensor 26, an axis of rotation 28, and the static structure 58 as shown in FIG. 1. The axial slip ring assembly 76 axially transfers the current from the power source 14 to the coil winding 20. The axial slip ring assembly 76 includes a slip ring housing 78, a first slip ring 80, a second slip ring 82, a brush housing 84, a plurality of brushes 86, and a plurality of springs 88. The slip ring housing 78 is axially installed on the SEM rotor 12 and mounted to the rotor shaft 16, rotating with the rotor shaft 16. The slip ring housing 78 includes an axial slip ring housing face 90, an inner groove 92, an outer groove 94, and a middle surface 96.

The axial slip ring housing face 90 is perpendicular to the axis of rotation 28. The inner groove 92, the outer groove 94, and the middle surface 96 are disposed on the axial slip ring housing face 90. The inner groove 92 and the outer groove 94 are axially staggered. The outer groove 94 is axially inward, toward the coil winding 20, from the inner groove 92. The outer groove 94 is also radially outward from the inner groove 92. The middle surface 96 is positioned between the inner groove 92 and the outer groove 94.

The first slip ring 80 is disposed within the inner groove 92. The second slip ring 82 is disposed within the outer groove 94. The first slip ring 80 is axially aligned with the inner groove 92 and the second slip ring 82 is axially aligned with the outer groove 94, causing the first slip ring 80 and the second slip ring 82 to be axially staggered. Axially staggering the first slip ring 80 and the second slip ring 82 enables debris from the second slip ring 82 to fall radially outside of the first slip ring 80. Additionally, by axially staggering the first slip ring 80 and the second slip ring 82, wear and arcing concerns are improved.

The brush housing 84 is axially installed on the SEM rotor 12 and is mounted to the static structure 58. The brush housing 84 may be directly mounted to the static structure 58 with a bolt or a screw. The brush housing 84 is adjacent to the slip ring housing 78. The brush housing 84 includes an axial brush housing face 98. The axial brush housing face 98 is parallel to the axial slip ring housing face 90. The axial brush housing face 98 is axially staggered, matching the contour of the axial slip ring housing face 90. The axial brush housing face 98 defines a plurality of slots 100 which are perpendicular to the axial brush housing face 98. The plurality of brushes 86 and the plurality of springs 88 are axially disposed within the plurality of slots 100.

The plurality of springs 88 apply a consistent axial force along the axis of rotation 28 against the plurality of brushes 86. The consistent axial force urges the plurality of brushes 86 to apply a constant axial force against the first slip ring 80 and the second slip ring 82. The constant axial force allows for the current applied by the power source 14 to transfer axially to and from the coil winding 20 through the first slip ring 80 and the second slip ring 82.

The axial slip ring assembly 10, 72, and 76 of the present disclosure offers several advantages. The advantages include installation of the axial slip ring assembly 10, 72, and 76 without an installation sleeve, decreasing the packaging space. With the decreased packaging space during installation, positioning opportunities for the axial slip ring assembly 10, 72, 76 on the SEM rotor 12 increase. Additionally, by installing the axial slip ring assembly 10, 72, and 76 axially, the installation process becomes easier with improved control of loading the axial slip ring assembly 10, 72, and 76.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An axial slip ring assembly for enabling a power transfer in a separately excited motor (SEM) rotor including a rotor shaft and a coil winding, the SEM rotor defining an axis of rotation, the axial slip ring assembly comprising:
a slip ring housing, wherein the slip ring housing is mounted to the rotor shaft of the SEM rotor and wherein the slip ring housing rotates about the axis of rotation;
a first slip ring, wherein the first slip ring is disposed within the slip ring housing and rotates with the slip ring housing, wherein the first slip ring is connected to the coil winding of the SEM rotor, and wherein the first slip ring is perpendicular to the axis of rotation;
a second slip ring, wherein the second slip ring is disposed within the slip ring housing and rotates with the slip ring housing, wherein the second slip ring is connected to the coil winding of the SEM rotor, wherein the second slip ring is perpendicular to the axis of rotation, and wherein the second slip ring is positioned radially outward from the first slip ring;
a brush housing, wherein the brush housing includes an axial brush housing face, wherein the axial brush housing face is perpendicular to the axis of rotation;
a plurality of brushes, wherein the plurality of brushes is disposed within the brush housing; and
a plurality of springs, wherein the plurality of springs is disposed within the brush housing and wherein the plurality of springs applies an axial force along the axis of rotation to urge the plurality of brushes to apply a constant axial force against the first slip ring and the second slip ring.

2. The axial slip ring assembly of claim 1, wherein the slip ring housing further comprises an axial slip ring housing face disposed parallel to the axial brush housing face.

3. The axial slip ring assembly of claim 1, wherein the slip ring housing further comprises an inner groove and wherein the first slip ring is disposed within the inner groove.

4. The axial slip ring assembly of claim 3, wherein the slip ring housing further comprises an outer groove, wherein the second slip ring is disposed within the outer groove, and wherein the outer groove is radially outward from the inner groove.

5. The axial slip ring assembly of claim 4, wherein the slip ring housing further comprises a middle surface, wherein the middle surface is positioned between the inner groove and the outer groove.

6. The axial slip ring assembly of claim 1, wherein the axial brush housing face defines slots parallel to the axis of rotation, wherein the plurality of brushes is disposed within the slots, and wherein the plurality of springs is disposed within the slots.

7. The axial slip ring assembly of claim 1, wherein the plurality of brushes further comprises:
a first end, wherein the first end is in contact with the plurality of springs; and
a second end, wherein the second end opposes the first end and wherein the second end applies a constant axial force against the first slip ring and the second slip ring along the axis of rotation.

8. The axial slip ring assembly of claim 1, wherein the axial slip ring assembly further comprises a static structure, wherein the static structure is stationary, and wherein the brush housing is mounted to the static structure.

9. The axial slip ring assembly of claim 1, wherein the plurality of brushes, the first slip ring, and the second slip ring are axially aligned.

10. The axial slip ring assembly of claim 1, wherein the plurality of brushes, the first slip ring, and the second slip ring are axially staggered.

11. The axial slip ring assembly of claim 1, wherein the plurality of brushes is circumferentially staggered within the brush housing.

12. The axial slip ring assembly of claim 1, wherein the plurality of brushes is circumferentially aligned within the brush housing.

13. The axial slip ring assembly of claim 1, wherein the plurality of brushes includes a positive set and a negative set.

14. The axial slip ring assembly of claim 1, wherein the axial slip ring assembly further comprises a power source and wherein the power source applies a current to the plurality of brushes.

15. The axial slip ring assembly of claim 14, wherein the plurality of brushes transfers the current to the first slip ring through the coil winding to the second slip ring.

16. The axial slip ring assembly of claim 15, wherein the first slip ring transfers the current to the coil winding and wherein the current in the coil winding creates a magnetic field, rotating the SEM rotor.

17. A separately excited motor (SEM) rotor to enable a power transfer defining an axis of rotation, the SEM rotor comprising:
a rotor shaft, wherein the rotor shaft rotates about the axis of rotation;
a laminate, wherein the laminate is connected to the rotor shaft and wherein the laminate rotates with the rotor shaft;
a coil winding, wherein the coil winding is wound within the laminate;
a gear, wherein the gear is mounted to the rotor shaft and wherein the gear rotates with the rotor shaft;
an axial slip ring assembly, the axial slip ring assembly including:
a slip ring housing, wherein the slip ring housing is mounted to the rotor shaft and wherein the slip ring housing rotates with the rotor shaft;
a first slip ring, wherein the first slip ring is disposed within the slip ring housing, wherein the first slip ring rotates with the slip ring housing, wherein the first slip ring is connected to the coil winding of the SEM rotor, and wherein the first slip ring is perpendicular to the axis of rotation;
a second slip ring, wherein the second slip ring is disposed within the slip ring housing, wherein the second slip ring rotates with the slip ring housing, wherein the second slip ring is connected to the coil winding of the SEM rotor, wherein the second slip ring is perpendicular to the axis of rotation, and wherein the second slip ring is positioned radially outward from the first slip ring;
a brush housing, wherein the brush housing includes an axial brush housing face and wherein the axial brush housing face is perpendicular to the axis of rotation;
a static structure, wherein the static structure is stationary and wherein the brush housing is mounted to the static structure;
a plurality of brushes, wherein the plurality of brushes is disposed within the brush housing;
a plurality of springs, wherein the plurality of springs is disposed within the brush housing and wherein the plurality of springs apply an axial force along the axis of rotation to urge the plurality of brushes to urge the plurality of brushes to apply a constant axial force against the first slip ring and the second slip ring; and
a power source, wherein the power source supplies a current to the plurality of brushes,
wherein the plurality of brushes transfers the current from the power source to the first slip ring through the coil winding to the second slip ring,
wherein the first slip ring transfers the current to the coil winding, and
wherein the current in the coil winding creates a magnetic field, rotating the SEM rotor about the axis of rotation.

18. The SEM rotor of claim 17, wherein the SEM rotor further comprises a ferrous wheel, wherein the ferrous wheel is attached to the gear, and wherein the ferrous wheel rotates with the rotor shaft.

19. The SEM rotor of claim 18, wherein the SEM rotor further comprises a speed sensor, wherein the speed sensor is stationary, wherein the speed sensor is adjacent to the ferrous wheel, and wherein the speed sensor calculates the speed of the rotor by detecting the ferrous wheel while the ferrous wheel rotates.

20. An axial slip ring assembly for enabling a power transfer in a separately excited motor (SEM) rotor including a rotor shaft and a coil winding, the SEM rotor defining an axis of rotation, the axial slip ring assembly comprising:
a slip ring housing, wherein the slip ring housing is mounted to the rotor shaft of the SEM rotor and wherein the slip ring housing rotates about the axis of rotation;
a first slip ring, wherein the first slip ring is disposed within the slip ring housing, wherein the first slip ring rotates with the slip ring housing, wherein the first slip ring is connected to the coil winding of the SEM rotor, and wherein the first slip ring is perpendicular to the axis of rotation;
a second slip ring, wherein the second slip ring is disposed within the slip ring housing, wherein the second slip ring rotates with the slip ring housing, wherein the second slip ring is connected to the coil winding of the SEM rotor, wherein the second slip ring is perpendicular to the axis of rotation, and wherein the second slip ring is positioned radially outward from the first slip ring;
a brush housing, wherein the brush housing includes an axial brush housing face, wherein the axial brush housing face is disposed perpendicular to the axis of rotation;
a static structure, wherein the static structure is stationary and wherein the brush housing is mounted to the static structure;
a plurality of brushes, wherein the plurality of brushes is disposed within the brush housing;
a plurality of springs, wherein the plurality of springs is disposed within the brush housing and wherein the plurality of springs applies an axial force along the axis of rotation to urge the plurality of brushes to urge the plurality of brushes to apply a constant axial force against the first slip ring and the second slip ring; and
a power source, wherein the power source applies a current to the plurality of brushes,
wherein the plurality of brushes transfers the current to the first slip ring through the coil winding to the second slip ring,
wherein the first slip ring transfers the current to the coil winding, and
wherein the current in the coil winding creates a magnetic field, rotating the SEM rotor about the axis of rotation.
